(19) United States
(12) Patent Application Publication
(10) Pub. No.: US 2006/0200631 A1
(43) Pub. Date: Sep. 7, 2006

(54) Control circuit and control method

(75) Inventors: Seiji Seki, Tokyo (JP); Toshihisa Kamemaru, Tokyo (JP); Hiroyasu Negishi, Tokyo (JP); Junko Kobara, Tokyo (JP)

Correspondence Address: BIRCH STEWART KOLASCH & BIRCH, PO BOX 747, FALLS CHURCH, VA, 22040-0747, US

(73) Assignee: Mitsubishi Denki Kabushiki Kaisha

(21) Appl. No.: 11/068,862

(22) Filed: Mar. 2, 2005

(51) Int. Cl. G06F 13/28

(52) U.S. Cl. 711/137

(57) ABSTRACT

The present invention aims to prefetch data which is stored in a cache memory and whose probability of access is high by replacing data whose probability of access is low. On discriminating a cache miss of target data which is used for an operation process performed by an operation processing unit, a cache hit discriminating unit obtains the target data from a main memory. Further, when the cache hit discriminating unit discriminates a cache hit, an invalid data discriminating unit discriminates a cache line including the target data is the same as the one including data which has been used for the previous operation process. Then, when the invalid data discriminating unit discriminates the cache line including the target data is different from the cache line including the data used for the previous operation process, a prefetch controlling unit prefetches the data by replacing data stored in the main memory with the cache line including the data used for the previous operation process.

### BACKGROUND OF THE INVENTION

1. Field of the Invention

The present invention relates to a control circuit and a control method for controlling a cache memory.

2. Background Art

In a conventional prefetch control circuit, in which data is previously stored in a cache memory, the prefetch is controlled by not invalidating and keeping the data that has been once referenced, so that a cache hit rate becomes low in a system where there is low probability of re-referencing data that has been once referenced, and it takes long to supply the data.

JP 08-292913 shows an example in which data that has been once referenced is discarded at the time of replacement of data. A prefetch caching method is used for the prefetching method and its circuit of JP 08-292913, in which when prefetched data is pushed away from a prefetch buffer, referenced data is discarded, while data which has not been referenced is not discarded.

In the method according to JP 08-292913, since the referenced data is discarded from the prefetch buffer but not discarded from an instruction cache, the data remains in the cache memory even if there is low probability of re-referencing the data. Further, it is impossible to implement the system with small amount of hardware resource, such as, without using the prefetch buffer. That is, the system uses large amount of hardware resource, which causes a problem that an LSI (Large Scale Integration) chip for implementing the method costs high. Further, according to the method of JP 08-292913, there is another problem that data which has been skipped to read without being referenced because of branching remains as non-referenced data even if there is low probability of referencing the data in the future.

### SUMMARY OF THE INVENTION

To solve the above problems, the present invention aims to provide, for example, by storing in a cache memory data which is currently accessed or will be accessed, a prefetch control circuit which is especially effective in a system that processes data to which there is low probability of re-referencing after the data is once referenced and that can be implemented with less amount of hardware resource.

According to the present invention, a control circuit includes: a main memory for storing data; a cache memory for reading and storing the data stored in the main memory by a unit of specific size as a cache line; an operation processing unit for inputting the data stored in the cache memory and performing an operation process based on the data input; a cache hit discriminating unit for discriminating a cache hit showing that target data which is used for the operation process performed by the operation processing unit is stored in the cache memory or a cache miss showing that the target data is not stored in the cache memory, and when the cache miss is discriminated, obtaining the target data from the main memory by the unit of specific size to store in the cache memory as a cache line; a data discriminating unit, when the cache hit discriminating unit discriminates the cache hit, for discriminating the cache line including the target data is different from the cache line including data used for a previous operation process; and a controlling unit for controlling caching operation, so that when the data discriminating unit discriminates the cache line including the target data is different from the cache line including the data used for the previous operation process, the data stored in the main memory is obtained by the unit of specific size, the data obtained by the unit of specific size is replaced with the cache line including the data used for the previous operation process, and the data obtained is stored in the cache memory as the cache line, and when the data discriminating unit discriminates the cache line including the target data is same as the cache line including the data used for the previous operation process, the cache line including the data used for the previous operation process is not replaced.

The controlling unit, when the data stored in the main memory is replaced with the cache line including the data used for the previous operation process, obtains data stored in a subsequent area to data which corresponds to a cache line other than the cache line to be replaced, replaces the cache line with the data obtained to store in the cache memory.

The cache memory reads a plurality pieces of the data stored in continuous areas in the main memory by the unit of specific size as the cache line and stores in continuous entries; and the controlling unit, when the data discriminating unit discriminates that the cache line including the target data is different from the cache line including data used for the previous operation process, obtains a plural pieces of the data stored in the main memory by the unit of specific size, replaces cache lines from an entry of the cache line including the data used for the previous operation process to an entry which is one entry before the cache line including the target data with the plurality pieces of the data obtained by the unit of specific size to store in the cache memory.

The control circuit further includes a command suspending unit for analyzing data included in the cache line stored in the cache memory, and as a result of analyzing, when at least one of data showing a branch instruction and data showing an end command is discriminated, suspending the controlling unit from replacing the data stored in the main memory with the cache line stored in the cache memory to store in the cache memory.

The operation processing unit includes: a cache accessing unit for inputting data from the cache memory; a decoding unit for decoding the data input by the cache accessing unit; and an operating unit for performing an operation process based on the data decoded by the decoding unit, and the cache accessing unit inputs data which is stored in the cache memory after the data that has been input, analyzes the data input, when the data analyzed shows a branch instruction, in parallel with the operation process by the operating unit, obtains data stored in a branched address shown by the data analyzed from the main memory to store in the cache memory.

According to another aspect of the invention, a control circuit includes: a main memory for storing data; a cache memory for reading and storing the data stored in the main memory by a unit of specific size as a cache line; an operation processing unit for inputting the data stored in the cache memory and performing an operation process based on the data input; a cache hit discriminating unit for discriminating a cache hit showing that target data which is used for the operation process performed by the operation processing unit is stored in the cache memory or a cache miss showing that the target data is not stored in the cache memory, and when the cache miss is discriminated, obtaining the target data from the main memory by the unit of specific size and storing in the cache memory as the cache line; and a controlling unit for controlling a caching operation, so that when the data discriminating unit discriminates the cache miss, data stored in an area, which is subsequent to an area storing data corresponding to the data stored in the cache memory as the cache line stored by the cache hit discriminating unit, in the main memory is obtained by the unit of specific size, the data obtained by the unit of specific size is replaced with a cache line other than the cache line which has been stored by the cache hit discriminating unit to store in the cache memory as a cache line.

According to another aspect of the invention, a control circuit includes: a main memory for storing data; a cache memory for reading the data stored in the main memory by a unit of a specific size as a cache line, storing the cache line, and discriminating whether the cache line stored is valid or invalid; an operation processing unit for inputting data of the cache line stored in the cache memory, and performing an operation process based on the data input; a controlling unit for controlling a caching operation before the operation process performed by the operation processing unit, so that the data stored in the main memory is obtained by the unit of specific size, the data obtained by the unit of specific size is replaced with an invalid cache line to store in the cache memory as a cache line; a standard value memory for storing at least one of a standard value of access frequency to the cache memory and a standard value of a number of valid cache lines stored in the cache memory; a measuring unit for measuring at least one of access frequency to the cache memory and a number of valid cache lines stored in the cache memory; and a measurement suspending unit, in at least one of cases when the access frequency to the cache memory measured by the measuring unit is equal to or less than the standard value of the access frequency stored in the standard value memory and when the number of valid cache lines measured by the measuring unit is equal to or greater than the standard value of the number of valid cache lines stored in the standard value memory, before the operation process, for suspending the controlling the caching operation from obtaining the data stored in the main memory by the unit of specific size, replacing the data obtained by the unit of specific size with the invalid cache line to store in the cache memory as a cache line.

According to another aspect of the invention, a control circuit includes: a main memory for storing data; a cache memory for reading and storing the data stored in the main memory; a cache accessing unit for inputting the data from the cache memory; a decoding unit for decoding the data input by the cache accessing unit; and an operating unit for performing an operation process based on the data decoded by the decoding unit, and the cache accessing unit, in parallel to the operation process by the operating unit, obtains from the main memory data stored in an address generated during the operation process performed by the operating unit to store in the cache memory.

According to another aspect of the invention, a control method includes: storing data in a main memory; reading and storing the data stored in the main memory by a unit of specific size as a cache line; inputting the data stored in the cache memory and performing an operation process based on the data input; discriminating a cache hit showing that target data which is used for the operation process is stored in the cache memory or a cache miss showing that the target data is not stored in the cache memory, when it is discriminated as the cache miss, obtaining the target data from the main memory by the unit of specific size to store in the cache memory as a cache line; when the cache hit is discriminated, discriminating the cache line including the target data is different from the cache line including data used for a previous operation process; and controlling a caching operation so that, when it is discriminated that the cache line including the target data is different from the cache line including the data used for the previous operation process, the data stored in the main memory is obtained by the unit of specific size, the data obtained by the unit of specific size is replaced with the cache line including the data used for the previous operation process to store in the cache memory as a cache line, and when it is discriminated that the cache line including the target data is same as the cache line including the data used for the previous operation process, the cache line including the data used for the previous operation process is not replaced.

According to another aspect of the invention, a control method includes: storing data in a main memory; reading and storing the data stored in the main memory by a unit of specific size as a cache line; inputting the data stored in the cache memory and performing an operation process based on the data input; discriminating a cache hit showing that target data which is used for the operation process is stored in the cache memory or a cache miss showing that the target data is not stored in the cache memory, and when it is discriminated as the cache miss, obtaining the target data from the main memory by the unit of specific size to store in the cache memory as a cache line; and when the cache miss is discriminated, obtaining data stored in an area, which is subsequent to an area storing data corresponding to the data stored in the cache memory as the cache line, in the main memory by the unit of specific size, and replacing the data obtained by the unit of specific size with a cache line other than the cache line which has been stored in the cache memory to store in the cache memory as a cache line.

According to another aspect of the invention, a control method includes: storing data in a main memory; reading the data stored in the main memory by a unit of a specific size as a cache line, storing the data as the cache line in a cache memory, and managing whether the cache line stored is valid or invalid; inputting data of the cache line stored in the cache memory, and performing an operation process based on the data input; controlling a caching operation before the operation processing, so that the data stored in the main memory is obtained by the unit of specific size, the data obtained by the unit of specific size is replaced with an invalid cache line to store in the cache memory as a cache line; storing in a standard value memory at least one of a standard value of access frequency to the cache memory and a standard value of a number of valid cache lines stored in the cache memory; measuring at least one of access frequency to the cache memory and a number of valid cache lines stored in the cache memory; and in at least one of cases when the access frequency to the cache memory measured is equal to or less than the standard value of the access frequency stored in the standard value memory and when the number of valid cache lines measured is equal to or greater than the standard value of the number of valid cache lines stored in the standard value memory, before the operation process, suspending the controlling the caching operation from obtaining the data stored in the main memory by the unit of specific size, replacing the data obtained by the unit of specific size with the invalid cache line to store in the cache memory as a cache line.

According to yet another aspect of the invention, a control method includes: storing data in a main memory; reading the data stored in the main memory and storing in a cache memory; inputting the data from the cache memory; decoding the data input; and performing an operation process based on the data decoded, when the data is input from the cache memory, in parallel with the operation process, obtaining data in an area shown by an address generated during the operation process to store in the cache memory.

### BRIEF DESCRIPTION OF THE DRAWINGS

A complete appreciation of the present invention and many of the attendant advantages thereof will be readily obtained as the same becomes better understood by reference to the following detailed description when considered in connection with the accompanying drawings, wherein:

FIG. 1 is a block diagram showing a configuration of a prefetch control circuit 100 according to the first embodiment;

FIG. 2 is a flowchart showing an operation of the prefetch control circuit 100 according to the first embodiment;

FIG. 3 shows a configuration of an operation processing unit 1 according to the fourth embodiment;

FIG. 4 shows an operation of the operation processing unit 1 according to the fourth embodiment;

FIG. 5 is a block diagram showing a configuration of a prefetch control circuit 100 according to the fifth embodiment;

FIG. 6 is a flowchart showing an operation of a measurement prefetch suspending unit 8 according to the fifth embodiment;

FIG. 7 is a block diagram showing a configuration of the prefetch control circuit 100 according to the sixth embodiment; and

FIG. 8 is a block diagram showing a hardware configuration of the prefetch control circuit 100 according to the embodiments.

### DESCRIPTION OF THE PREFERRED EMBODIMENT

### Embodiment 1

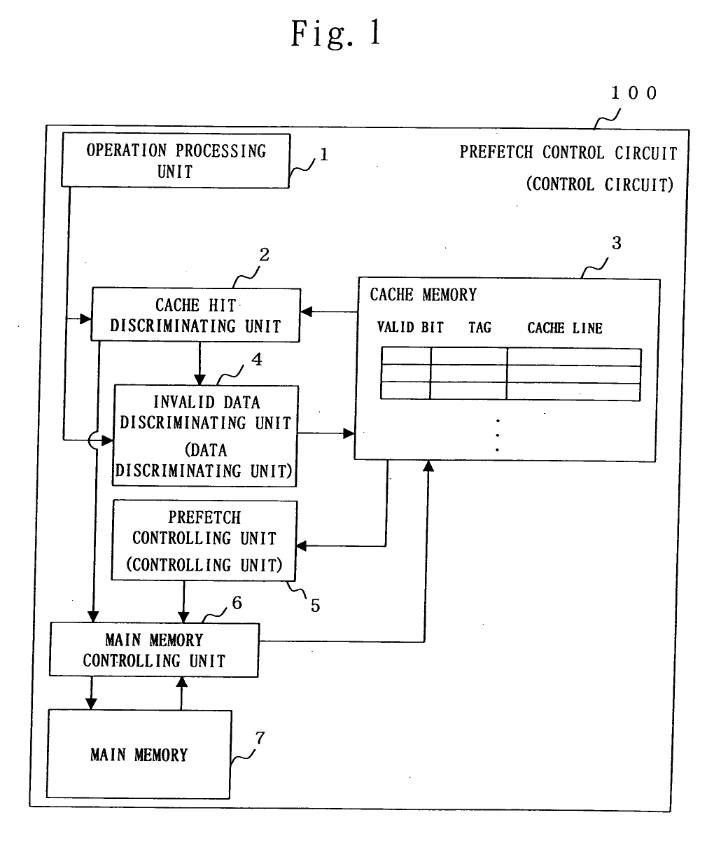

FIG. 1 shows a block diagram of a prefetch control circuit 100 according to the first embodiment.

In FIG. 1, a reference numeral 1 shows an operation processing unit which accesses a cache memory 3, reads data from the cache memory 3, and performs an operation on the read data.

2 shows a cache hit discriminating unit which discriminates whether a target data exists in the cache memory 3 or not at accessing time to the cache memory 3.

3 is a cache memory which stores data by a cache line unit.

4 is an invalid data discriminating unit which invalidates a cache line stored in the cache memory 3 based on the access to the cache memory 3.

5 shows a prefetch controlling unit which, when a valid cache line and an invalid cache line exist in the cache memory 3, obtains an original address of the target data for prefetch from an address of the valid cache line, and reads the target data for prefetch from a main memory 7 to store in the cache memory 3.

6 is a main memory controlling unit which reads the data from a main memory 7 when a cache miss occurs or a prefetch is requested.

7 shows the main memory which stores various kinds of data such as command data or operational data. The command data shows contents of operation command of an operation process performed by the operation processing unit 1, and the operational data means target data for the operation indicated by the command data.

Here, a “cache line” means data of specific size which is stored and managed by the cache memory 3.

In general, the cache memory 3, which is used for compensating a difference between the processing speeds of a CPU (Central Processing Unit) and the main memory 7, manages the cache line by setting as an entry. Each entry includes a valid bit, a tag address, and a cache line.

The valid bit shows validness/invalidness of the entry, and the tag address shows an original address of the cache line.

The cache memory 3 specifies and outputs the accessed target data included in the cache line by searching the tag address which corresponds to the original address of the target data for the valid entry.

Next, the operation will be explained.

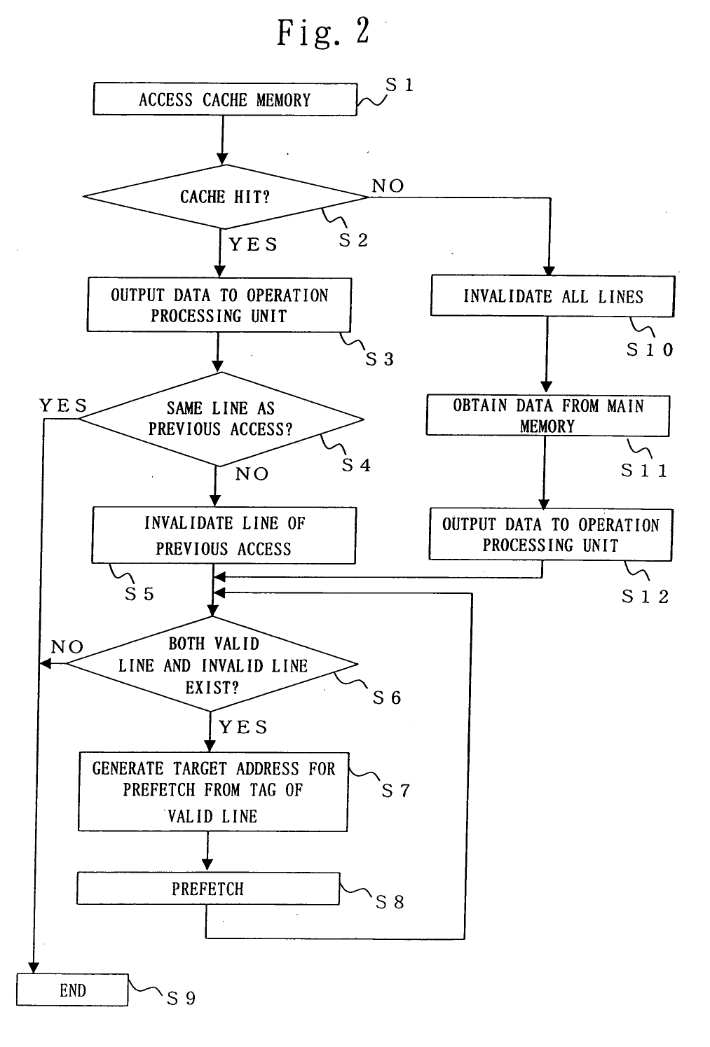

FIG. 2 is a flowchart showing the operation of the prefetch control circuit 100 according to the first embodiment.

Here, it is assumed that data, which has been stored in areas indicated by continuous addresses in the main memory 7, is stored in each entry of the cache memory 3 by accessing the main memory 7 last time. Further, the valid bit of each entry shows validness, which means the reading status of the data is valid.

First, the operation processing unit 1 accesses the cache memory 3 to read the data (step S1).

Here, the cache hit discriminating unit 2 outputs the original address of the target data for access of the operation processing unit 1 to the cache memory 3 and discriminates the existence of the target data for access in the cache memory 3 based on the output result of the cache memory 3 (step S2).

If the target data for access exists in the cache memory 3, the cache hit discriminating unit 2 discriminates a cache hit, extracts the target data for access from the cache memory 3 and outputs to the operation processing unit 1 (step S3).

Then, the invalid data discriminating unit 4 discriminates whether the cache line including the target data for access of the operation processing unit 1 is the same as the cache line including the data which has been accessed previously (step S4).

As a result of the discriminating by the invalid data discriminating unit 4, when the data currently accessed is in the same cache line as the data of previous access, the operation terminates. Consequently, no prefetching operation is carried out (step S9).

As a result of the discriminating by the invalid data discriminating unit 4, when the data currently accessed is in a different cache line from the data of previous access, the invalid data discriminating unit 4 invalidates the entry by setting the valid bit of the cache line including the data of previous access invalid. Here, it is assumed that the cache line including the target data for access is stored in the next entry to the cache line including the data of previous access (step S5).

Next, the prefetch controlling unit 5 discriminates whether the cache memory 3 includes both the valid cache line and the invalid cache line (step S6).

At this time, since the cache line which accessed previously is made invalid at step S5, and the other cache line remains valid, the prefetch controlling unit 5 discriminates that both the valid cache line and the invalid cache line exist.

Next, the prefetch controlling unit 5 generates a target address for prefetch from the address of the valid cache line so as to read out the data from the main memory 7 for the invalid cache line (step S7).

The prefetch controlling unit 5 replaces the data for the invalid cache line which has been accessed previously. First, the prefetch controlling unit 5 sets the next address in the main memory 7 of the data corresponding to the valid cache line included in an entry which is one entry prior to the invalid cache line as a target address for prefetch in order to store in the cache memory 3 the data stored in an area indicated by continuous addresses in the main memory 7.

Next, the prefetch controlling unit 5 issues an access request to the main memory controlling unit 6 so as to read data located in the target address for prefetch generated at step S7. Then, the main memory controlling unit 6 reads the data from the main memory 7, stores the data as a cache line in the cache memory 3, and validates the valid bit of the cache line (step S8).

The above prefetching operation enables to store the data located at the address subsequent to the new address in the cache memory 3.

After carrying out the prefetching operation at step S8, the prefetch controlling unit 5 discriminates again whether the cache memory 3 includes both the valid cache line and the invalid cache line (step S6).

Since the cache line including the data which has been previously accessed is replaced with the new cache line and validated at step S8, there is no invalid cache line in the cache memory 3. Therefore, no other prefetching operation is carried out and the operation terminates (step S9).

As has been discussed, when the cache line of the data accessed by the operation processing unit 1 is changed, the prefetch control circuit 100 in the first embodiment invalidates the cache line which has been referred to and can store the new data which may be accessed in the future in the cache memory 3.

Further, the data used for displaying drawings or images has characteristics that the data which has once been read from the main memory 7 and displayed on the screen will be seldom referenced again. Consequently, in the system for displaying drawings or images, the cache hit rate can be improved by storing new data rather than maintaining the referenced data in the cache memory 3.

Therefore, it is possible to access data at a high-speed and further to improve processing performance of the system by installing, for example, the prefetch control circuit 100 explained in the first embodiment in the system for displaying drawings or images.

Further, the prefetch control circuit 100 of the first embodiment can store in the cache memory 3 data stored in the subsequent area in the main memory 7 as new data which will be possibly referenced in the future by replacing the data located next to the data corresponding to the valid cache line in the main memory 7 with the invalid cache line.

Yet further, in the system for displaying drawings or images, the system usually stores a series of data of one screen in a continuous area in the main memory 7, so that the embodiment enables to improve the cache hit rate by storing in the cache memory 3 the data stored in the continuous area in the main memory 7.

Further, the prefetch control circuit 100 of the first embodiment uses the valid bit of the cache memory 3 for carrying out the prefetch control, which makes a flag unnecessary. Yet further, the prefetch control circuit 100 stores the prefetched data in the cache memory 3 and does not need an additional memory, which enables to implement a circuit to control the cache memory 3 with less amount of hardware resource.

However, in the prefetch control circuit 100, it is also possible to set a flag other than the valid bit of the cache memory 3, and to have a memory other than the cache memory 3.

### Embodiment 2

In the above first embodiment, the operation has been explained in which the operation processing unit 1 prefetches the data when the operation processing unit 1 accesses the cache memory 3 and a cache hit occurs.

In the second embodiment, another prefetching operation will be explained in reference to FIG. 2 when the operation processing unit 1 accesses the cache memory 3 and a cache miss occurs.

Similarly to the first embodiment, in FIG. 2, the operation processing unit 1 accesses the cache memory 3 (step S1), and the cache hit discriminating unit 2 discriminates whether the target data accessed by the operation processing unit 1 is stored in the cache memory 3 (step S2).

In case of a cache miss when the accessed data is not stored in the cache memory 3, the invalid data discriminating unit 4 judges all the cache lines invalid and invalidates the valid bits of all the cache lines (step S10).

Next, the cache hit discriminating unit 2 issues an access request to the main memory controlling unit 6 so as to read the data of the cache line corresponding to the address of the cache missed data. The main memory controlling unit 6 reads the data from the main memory 7, stores the data in the cache memory 3, and validates the valid bit of the cache line (step S11).

Further, after reading the data from the main memory 7 at step S11, the cache hit discriminating unit 2 outputs the target data for access to the operation processing unit 1 (step S12).

Subsequent operation will be processed in the same manner as the first embodiment.

The prefetch controlling unit 5 discriminates whether the cache memory 3 includes both the valid cache line and the invalid cache line (step S6).

At this time, since only the cache line, which is the data read from the main memory 7 at step S11 after the cache miss, is valid and the other cache lines are invalid, the prefetch controlling unit 5 discriminates that both the valid cache line and the invalid cache line exist.

The prefetch controlling unit 5 generates a target address for prefetch from the address of the valid cache line (step S7).

The prefetch controlling unit 5 generates a target address for prefetch in order to read data subsequent to the data corresponding to the valid cache line from the main memory 7, replace the read data with the invalid cache line to store in the cache memory 3. Here, the cache line of an entry next to the valid cache line is selected as the invalid cache line to be replaced. Further, the address of the data, located in the subsequent area to the corresponding data of the valid cache line in the main memory 7, is set as the target address for prefetch.

Next, the prefetch controlling unit 5 issues the access request to the main memory controlling unit 6 so as to read the data located in the target address for prefetch generated at step S7. Then, the main memory controlling unit 6 reads the data from the main memory 7, stores the data in the cache memory 3, and validates the valid bit of the cache line which stores the data (step S8).

The prefetching operation enables to store the data subsequent to the new address in the cache memory 3.

After the prefetching operation at step S8, the prefetch controlling unit 5 discriminates again whether the cache memory 3 includes both the valid cache line and the invalid cache line (step S6).

At this time, two cache lines are valid: the cache line to which the data is read from the main memory 7 after discriminating the cache miss; and the cache line to which the data is prefetched, and the others are invalid. Therefore, the prefetch controlling unit 5 discriminates that both the valid cache line and the invalid cache line exist.

The prefetch controlling unit 5 generates a target address for prefetch in order to read data subsequent to the data corresponding to the valid cache line from the main memory 7 and replace the read data with the invalid cache line to store in the cache memory 3. Here, the cache line of the next entry following the two valid cache lines is selected as the invalid cache line which is a target of replacement. Further, an address in the main memory 7 of data next to the data corresponding to the data of the second valid cache line is set as a target address for prefetch.

Next, the prefetch controlling unit 5 issues an access request to the main memory controlling unit 6 to read data of the target address for prefetch generated at step S7. Then, the main memory controlling unit 6 reads the data from the main memory 7 to store in the cache memory 3 and validates the valid bit of the cache line which stored the data (step S8).

The prefetching operation enables to store the data subsequent to the new address in the cache memory 3.

As discussed above, a series of prefetching operation from step S6 through step S8 is repeated until there is no invalid cache line. When there is no invalid cache line, no more prefetching operation is carried out and the process terminates (step S9).

By the prefetching operation in this way, it is possible to store in the cache memory 3 the data which has been stored in the continuous area in the main memory 7.

As has been described, when the data accessed by the operation processing unit 1 does not exist in the cache memory 3 and a cache miss occurs, it is judged there is high possibility that the cache memory 3 does not include the data stored in the location subsequent to the data accessed by the operation processing unit 1 in the main memory 7, and all the cache lines are made invalid. And the prefetching operation enables to fetch the data stored in the subsequent area to the cache memory 3.

For example, in the system for displaying drawings or images which usually stores a series of data of one screen in the continuous area in the main memory 7, it is possible to improve the cache hit rate and enable the operation processing unit 1 to access data at a high speed by storing in the cache memory 3 the data located in the continuous area in the main memory 7.

### Embodiment 3

In the foregoing first embodiment, the prefetch is carried out when the operation processing unit 1 accesses the data of the cache line of the entry next to the cache line of the previous access.

In the third embodiment, another prefetching operation will be explained referring to FIG. 2 when the operation processing unit 1 accesses the data of the cache line of an entry located at some entries away from the cache line of the previous access instead of the cache line of the next entry, and a cache hit occurs.

Here, it is assumed that the cache memory 3 stores the data which has been stored subsequently to the data of the previous access in the main memory 7 in a valid status.

The operation processing unit 1 accesses the cache memory 3 (step S1), and the cache hit discriminating unit 2 discriminates if the cache memory 3 includes the target data accessed by the operation processing unit 1 (step S2).

When the cache memory 3 does not include the target data and a cache miss occurs, the invalid data discriminating unit 4 invalidates all the cache lines (step S10), and the subsequent operation is carried out as shown in the second embodiment.

When the cache memory 3 includes the target data, the cache hit discriminating unit 2 extracts the data from the cache memory 3 and outputs the extracted data to the operation processing unit 1 (step S3).

Next, the invalid data discriminating unit 4 discriminates if the target data accessed by the operation processing unit 1 is on the same cache line as the data of the previous access (step S4).

As a result of the discriminating by the invalid data discriminating unit 4, when the target data of the current access is on the same cache line as the data of the previous access, the process terminates. Accordingly, no prefetching operation is carried out (step S9).

On the other hand, as a result of the discriminating by the invalid data discriminating unit 4, when the target data of the current access is on a different cache line, further, the target data is not on the cache line next to the cache line of the previous access, but on the cache line located at some entries away from the cache line of the previous access, the invalid data discriminating unit 4 invalidates the cache lines located from the cache line of the previous access to the cache line which is one line before the cache line of the current access, and the invalid data discriminating unit 4 also invalidates the valid bits of these cache lines. In the first embodiment, the target cache line of the current access is located next to the cache line of the previous access (step S5), so that the cache line of the previous access is made invalid. In the third embodiment, the target cache line of the current access is located at some entries away from the cache line of the previous access, so that the cache lines which are skipped by the operation processing unit 1 are made invalid as well as the cache line of the previous access.

Next, the prefetch controlling unit 5 discriminates again if the cache memory 3 includes both the valid cache line and the invalid cache line (step S6).

Since the cache lines from the cache line of the previous access to the cache line which is one line before the cache line of the current access are invalid and the other cache lines are valid, the prefetch controlling unit 5 discriminates that the cache memory 3 includes both the valid cache line and the invalid cache line.

Next, the prefetch controlling unit 5 generates a target address for prefetch from the address of the valid cache line (step S7).

The prefetch controlling unit 5 generates the target address for prefetch in order to read the data corresponding to the valid cache line from the main memory 7, and replace the read data with the invalid cache line to store in the cache memory 3. Here, the cache line of the previous access is selected as the invalid cache line of the target of replacement. Further, the target address for prefetch is set by an address of the data located next to the data in the valid cache line stored in the previous entry of the invalid cache line which is the target of replacement in the main memory 7.

Next, the prefetch controlling unit 5 issues an access request to the main memory controlling unit 6 in order to read the data of the target address for prefetch generated at step S7 from the main memory 7. The main memory controlling unit 6 reads the data from the main memory 7, stores the data in the cache memory 3, and validates the valid bit of the cache line (step S8).

The prefetching operation enables to store the data subsequent to the new address in the cache memory 3.

After the prefetching operation at step S8, the prefetch controlling unit 5 discriminates again if the cache memory 3 includes both the valid cache line and the invalid cache line (step S6).

Since only one cache line is validated at step S8 after the cache lines from the cache line of the previous access to the cache line which is one line before the current access are invalidated at step S5, the prefetch controlling unit 5 discriminates that the cache memory 3 includes both the valid cache line and the invalid cache line.

Next, the prefetch controlling unit 5 reads the data stored in an area subsequent to the data of the valid cache line from the main memory 7 and generates the target address for prefetch in order to replace the read data with the invalid cache line to store in the cache memory 3. Here, the cache line of the next entry which is subsequent to the cache line validated at the above step S8 is selected as the invalid cache line which is the target of replacement. Further, the target address for prefetch is set by an address in the main memory 7 of the data located next to the data corresponding to the data in the valid cache line stored in the previous entry of the invalid cache line which is the target of replacement.

Next, the prefetch controlling unit 5 issues an access request to the main memory controlling unit 6 in order to read the data of the generated target address for prefetch. The main memory controlling unit 6 reads the data from the main memory 7, stores the read data in the cache memory 3, and validates the valid bit of the cache line (step S8).

By this prefetching operation, it is possible to store in the cache memory 3 the data corresponding to the data which is stored in an area subsequent to the data of valid cache line in the main memory 7.

Then, a series of the prefetching operation shown in steps S6 through S8 is repeated until there is no invalid cache line. When there exists no invalid cache line, the prefetching operation terminates (step S9).

By carrying out the prefetching operation in this manner, it is possible to store in the cache memory 3 the data stored in a continuous area in the main memory 7.

When the operation processing unit 1 accesses the data on, not the next cache line, the cache line located at some entries away from the cache line of the previous access and the cache hit discriminating unit 2 discriminates a cache hit, it can be judged the probability is low that the cache lines which have been skipped to read by the operation processing unit 1 are accessed. Therefore, the third embodiment invalidates from the cache line of the previous access to the cache line one line before the cache line of the current access, and then, the prefetching operation enables to obtain the data stored in an area subsequent to the data of the current access to the cache memory 3.

For example, in the system for displaying drawings or images, since the system usually stores a series of data of one screen in the continuous area in the main memory 7, the probability is high to access the data stored continuously, and on the contrary, the probability is low to access the data which has been skipped to read. Therefore, it is possible to improve the cache hit rate by removing the skipped data from the cache memory 3 and storing in the cache memory 3 the data which has been stored in the subsequent area to the newly accessed data. Thus, the speed of data access by the operation processing unit 1 can be improved.

### Embodiment 4

In the foregoing embodiments, the prefetching operation is carries out when the operation processing unit 1 accesses the cache memory based on the result of the operation process.

In the fourth embodiment, another prefetching operation will be explained, in which the operation processing unit 1 computes an address required for the next operation based on a branch instruction or operational data during the operation process and carries out a look-ahead access to the cache memory.

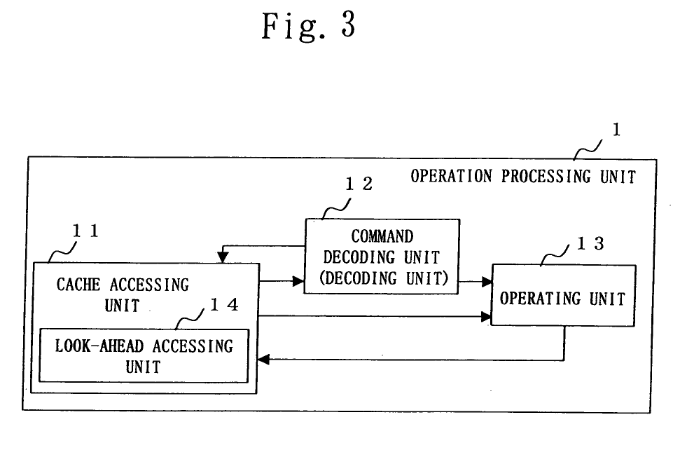

FIG. 3 shows a configuration of the operation processing unit 1 according to the fourth embodiment.

In FIG. 3, a reference numeral 11 shows a cache accessing unit for reading data from the cache memory 3 and dividing the read data into command data and operational data.

A reference numeral 12 shows a command decoding unit for decoding a command of the command data divided by the cache accessing unit 11.

13 shows an operating unit for performing an operation process of the operational data according to the command decoded by the command decoding unit 12.

14 shows a look-ahead accessing unit for computing an address of data required for the next access based on branch command or the operational data and issuing a request for look-ahead access to the cache accessing unit 11.

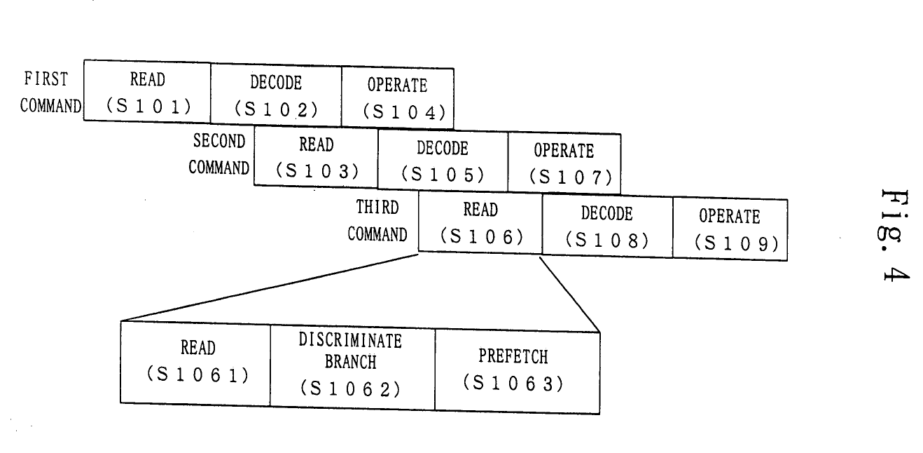

FIG. 4 shows the operation of the operation processing unit 1 in the fourth embodiment.

The operation of the operation processing unit 1 according to the fourth embodiment will be explained referring to FIG. 4 for a normal access to the cache memory 3 from the operation processing unit 1 and a look-ahead access.

First, the operation of the normal access to the cache memory 3 from the operation processing unit 1, not the look-ahead access, will be explained.

In the operation processing unit 1, the cache accessing unit 11 reads the data stored in the cache memory 3 and outputs the read data to the command decoding unit 12 (step S101).

The command decoding unit 12 decodes the read command data and outputs the decoded command data to the operating unit 13. Further, as a result of the decoding process, if the command data shows a command which requires the operational data, the command decoding unit 12 requests the cache accessing unit 11 to read the operational data (step S102).

After reading the operational data, the cache accessing unit 11 reads the next (the second) data from the cache memory 3 (step S103).

Further, the operating unit 13 reads the command data and the operational data, and the operation is performed when it becomes possible (step S104).

During the operation is performed by the operating unit 13, the command decoding unit 12 decodes the next (the second) command data. Then, if the command data shows a command which requires the operational data, the command decoding unit 12 requests the cache accessing unit 11 to read the operational data (step S105).

After reading the operational data, the cache accessing unit 11 reads the next (the third) data from the cache memory 3 (step S106).

After finishing the operation process of the first command data, the operating unit 13 inputs the next (the second) command decoded by the command decoding unit 12 and starts the operation process (step S107).

Then, the command decoding unit 12 decodes the next (the third) data. Further, if the command data shows a command which requires the operational data, the command decoding unit 12 requests the cache accessing unit 11 to read the operational data (step S108).

After reading the operational data, the cache accessing unit 11 reads the next (the fourth) data from the cache memory 3 (step S103).

In this way, the operation processing unit 1 reads the command data and the operational data from the cache memory 3 and continues the processing. Upon reading an end command or receiving an end signal, the operation processing unit 1 finishes reading the command data and the operational data from the cache memory 3.

Next, an operation for carrying out the look-ahead access to the cache memory 3 from the operation processing unit 1 will be explained.

It is assumed that the third command data stores a branch instruction in the above example of normal access.

The third command data of the above example of normal access is read by the cache accessing unit 11 from the cache memory 3 during the operation process of the first command by the operation processing unit 1 (step S106i).

Then, the look-ahead accessing unit 14 discriminates the branch instruction from the third command data before the operating unit 13 finishes the operation process of the first command, and the look-ahead accessing unit 14 requests for the look-ahead access of the data shown by an branched address included in the command data (step S1062).

For the branched address included in the request for look-ahead access issued by the look-ahead accessing unit 14, the cache hit discriminating unit 2 discriminates a cache miss, the prefetching operation is carried out as shown in the above second embodiment, and the data stored in an area subsequent to the branched address is stored in the cache memory 3 (step S1063).

After finishing the operation process of the first command, the operating unit 13 starts the operation process of the second command data (step S107).

In parallel to this, the command decoding unit 12 decodes the next (the third) data. As a result of the decoding, the command decoding unit 12 discriminates the branch instruction. Then, the command decoding unit 12 requests the cache accessing unit 11 to read the data of the branched address, and the cache memory 3 is accessed (step S108).

Here, since the data of the branched address is already stored in the cache memory 3 by the look-ahead accessing unit 14, the cache hit discriminating unit 2 discriminates a cache hit, and the data of the branched address can be immediately obtained in the cache accessing unit 11 of the operation processing unit 1.

In the above embodiment of the look-ahead access, the data of the branched address indicated by the branch instruction is foreseen; however, it is also possible that the operation processing unit 1 carries out the look-ahead access to the cache memory 3 for the data of the address generated during the operation process.

As discussed, since the operation processing unit 1 computes the address of the data required for the next operation from the branch instruction or the operational data and carries out the look-ahead access to the cache memory 3, the data which will be required next can be stored in the cache memory 3 before reading the data of the branched address after the operation process. Accordingly, it is possible to reduce the delay due to the cache miss which may occur during access by the operation processing unit 1, which enables a high-speed operation.

### Embodiment 5

In the foregoing embodiment, the prefetch controlling unit 5 carries out the prefetching operation until there is no invalid cache line.

In the fifth embodiment, the prefetching operation is suspended when the frequency of reading access from the operation processing unit 1 is low or the number of valid cache lines stored in the cache memory 3 is large.

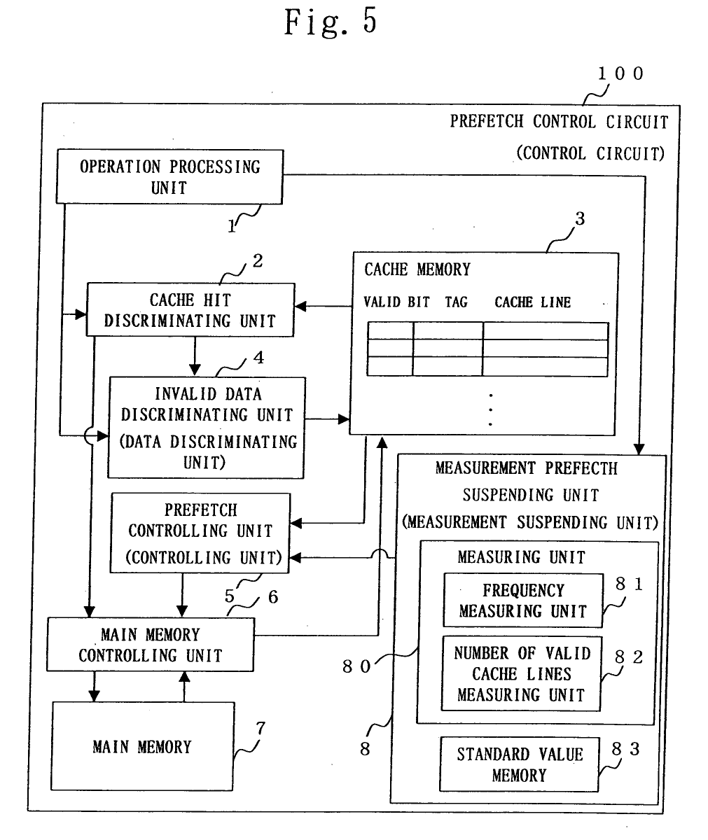

FIG. 5 is a diagram showing a configuration of a prefetch control circuit 100 according to the fifth embodiment.

In FIG. 5, 1 through 7 are the same as ones explained in the above first embodiment. However, the prefetch controlling unit 5, on receiving a prefetch suspending request, does not carry out the prefetching operation even if both the valid cache line and the invalid cache line exist.

A reference numeral 8 shows a measurement prefetch suspending unit for suspending the prefetching operation when the frequency of reading access is low and there are more valid cache lines than a standard value.

80 shows a measuring unit which includes a frequency measuring unit 81 and a number of valid cache lines measuring unit 82.

81 is the frequency measuring unit for measuring the frequency of reading access to the cache memory 3 from the operation processing unit 1.

82 is the number of valid cache lines measuring unit for measuring the number of valid cache lines of the cache memory 3.

83 is a standard value memory for storing a standard value of the access frequency which is used for judging that the access frequency is low and for storing a standard value of the number of valid cache lines.

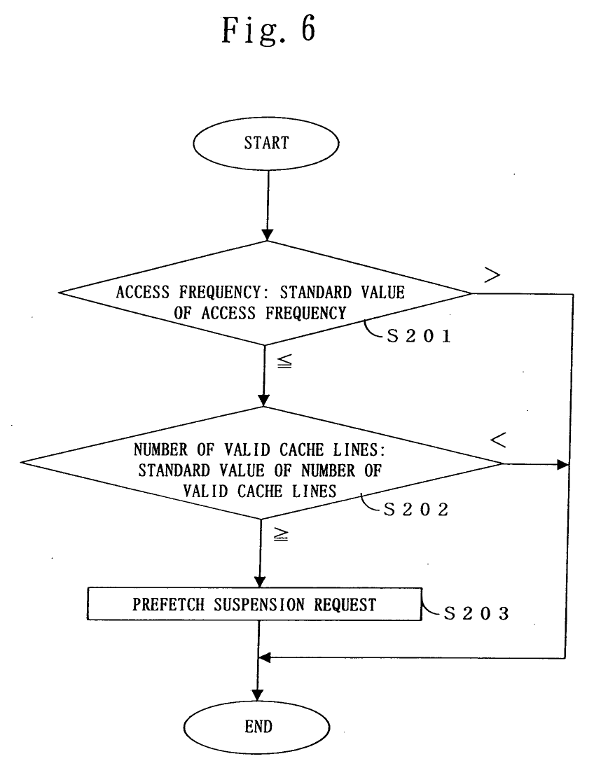

FIG. 6 is a flowchart showing an operation of the measurement prefetch suspending unit 8 according to the fifth embodiment.

The operation of the measurement prefetch suspending unit 8 will be explained referring to FIG. 6.

Here, it is assumed that the standard value of the access frequency which is used for judging that the access frequency to the cache memory 3 from the operation processing unit 1 is low and the standard value of the number of cache lines which are sufficiently valid for the standard value of the access frequency are set in the standard value memory 83.

If the value measured by the access frequency measuring unit 81 is greater than the standard value of the access frequency stored in the standard value memory 83, the measurement prefetch suspending unit 8 does not send the prefetch controlling unit 5 the prefetch suspension request (step S201).

When the value measured by the access frequency measuring unit 81 is equal to or less than the standard value of the access frequency, the measurement prefetch suspending unit 8 discriminates if the value measured by the number of valid cache lines measuring unit 82 is equal to or greater than the standard value of the number of valid cache lines stored in the standard value memory 83. If the measured value is not equal to or greater than the standard value, the measurement prefetch suspending unit 8 does not send the prefetch controlling unit 5 the prefetch suspension request (step S202).

If the value measured by the access frequency measuring unit 81 is equal to or less than the standard value of the access frequency and further the value measured by the number of valid cache lines measuring unit 82 is equal to or greater than the standard value of the number of valid cache lines, the measurement prefetch suspending unit 8 send the prefetch controlling unit 5 the prefetch suspension request (step S203).

When the prefetch suspension request is received from the measurement prefetch suspending unit 8, the prefetch controlling unit 5 does not generate the target address for prefetch and does not carry out the prefetching operation even if both the valid cache line and the invalid cache line are discriminated at step S6 in FIG. 2.

Further, after the measurement prefetch suspending unit 8 sends the prefetch controlling unit 5 the prefetch suspension request, if the value measured by the access frequency measuring unit 81 becomes greater than the standard value of the access frequency or the value measured by the number of valid cache lines measuring unit 82 becomes less than the standard value of the number of valid cache lines, the measurement prefetch suspending unit 8 sends the prefetch controlling unit 5 a prefetch suspension release request.

Here, the above standard values of the access frequency and the number of valid cache lines are arbitrary.

In the foregoing explanation, the prefetch is suspended when the access frequency is equal to or less than the standard value and further the number of valid cache lines is equal to or greater than the standard value. However, the prefetch can be suspended when the access frequency is equal to or less than the standard value or when the number of valid cache lines is equal to or greater than the standard value.

When the access frequency is low, the necessity of reading much data from the main memory 7 and storing in the cache memory 3 is low, it is better to suspend the prefetching operation to access the main memory 7 in the above-described way.

For example, when a cache miss occurs on reading data from the branched address for the branch instruction, all the data stored in the cache memory 3 becomes invalid. In such a case, the suspension enables to minimize a loss of the process of prefetching from the main memory 7.

By the above operation, it is possible to reduce the number of accesses to the main memory 7 due to the prefetching operation, which can reduce the power consumed by the prefetching operation.

### Embodiment 6

In the foregoing fifth embodiment, the prefetching operation is suspended when the access frequency of reading from the operation processing unit 1 is low and further the number of valid cache lines is large.

In the sixth embodiment, the branch instruction and the end command are discriminated from the data read from the main memory 7 by the cache memory 3, and the prefetching operation is suspended if such instruction or command exists.

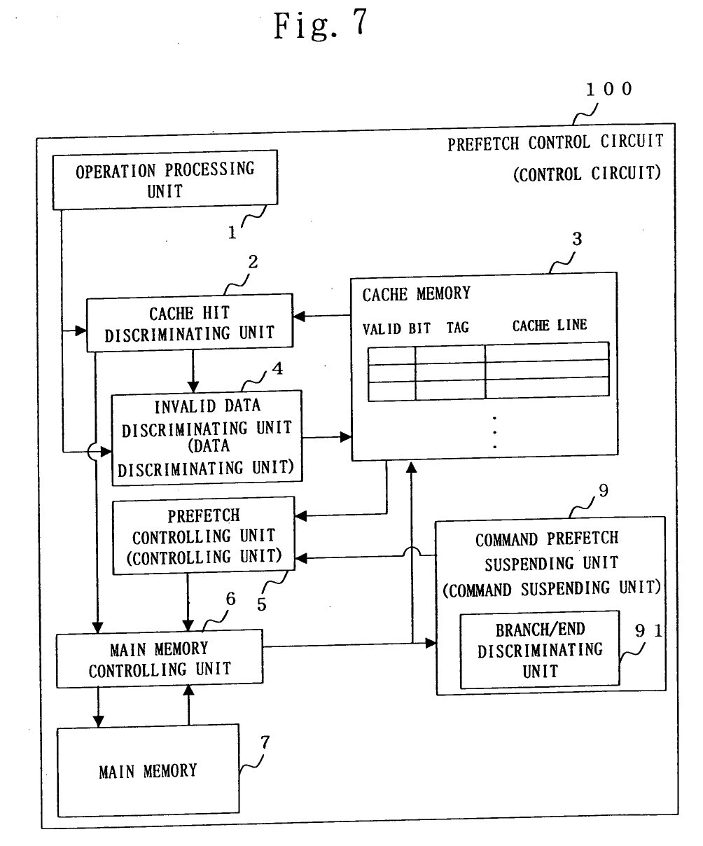

FIG. 7 is a block diagram showing a configuration of the prefetch control circuit 100 according to the sixth embodiment.

In FIG. 7, reference numerals 1 through 7 are the same as ones explained in the first embodiment. However, when the prefetch suspension request is received, the prefetch controlling unit 5 does not carry out the prefetching operation even if both the valid cache line and the invalid cache line exist.

A reference numeral 9 shows a command prefetch suspending unit for discriminating the branch instruction or the end command in the data read from the main memory 7 by the cache memory 3, suspending the prefetching operation if such instruction or command exists, and releasing the suspension if the cache memory 3 stores a command different from the branch instruction or the end command.

91 shows a branch/end discriminating unit for discriminating the branch instruction or the end command in the data read from the main memory 7.

Next, the operation will be explained.

On reading the data from the main memory 7, the main memory controlling unit 6 sends the data to the cache memory 3 and the command prefetch suspending unit 9.

The branch/end discriminating unit 91 analyzes the data sent to the command prefetch suspending unit 9 and discriminates the branch instruction or the end command in the data.

When none of the branch instruction and the end command exists in the data sent to the command prefetch suspending unit 9, the command prefetch suspending unit 9 does not send the prefetch controlling unit 5 the prefetch suspension request.

If at least one of the branch instruction and the end command exists in the data sent to the command prefetch suspending unit 9, the command prefetch suspending unit 9 sends the prefetch controlling unit 5 the prefetch suspension request.

When the prefetch suspension request is received from the command prefetch suspending unit 9, the prefetch controlling unit 5 does not generate the target address for prefetch and does not carry out the prefetching operation even if both the valid cache line and the invalid cache line are discriminated at step S6 in FIG. 2.

Further, after the command prefetch suspending unit 9 sends the prefetch controlling unit 5 the prefetch suspension request, when the command data other than the branch instruction or the end command is stored in the cache memory 3, the command prefetch suspending unit 9 sends the prefetch controlling unit 5 the prefetch suspension release request.

When the branch instruction or the end command is stored in the cache memory 3, if the data of the subsequent address is stored in the cache memory 3, the probability is low to access such data. By the above operation, it is possible to suspend unnecessary access to the main memory 7 due to the prefetching operation.

For example, when a cache miss occurs on reading data from the branched address for the branch instruction, all the data stored in the cache memory 3 becomes invalid. In such a case, the suspension enables to minimize a loss of the process of prefetching from the main memory 7. By the above operation, it is possible to reduce the number of accesses to the main memory 7 due to the prefetching operation, which can reduce the power consumed by the prefetching operation.

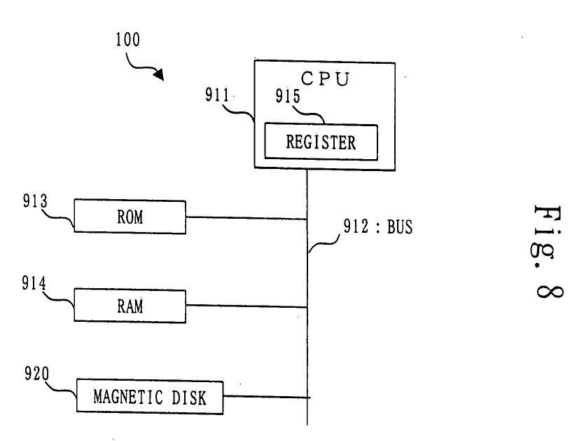

FIG. 8 is a configuration of hardware of the prefetch control circuit 100 according to each of the foregoing embodiments.

In FIG. 8, the prefetch control circuit 100 includes a CPU 911 for executing programs. The CPU 911 is connected to a ROM 913, a RAM 914, and a magnetic disk drive 920 via a bus 912.

The RAM 914 is an example of a volatile memory. The ROM 913 and the magnet disk drive 920 are examples of nonvolatile memory. These are examples of a memory device or a storage unit.

The above cache memory 3 mainly uses a Statistic RAM as the recording medium, and the main memory 7 uses a Dynamic RAM or the magnet disk drive 920 as the recording medium.

Further, the operation processing unit 1 carries out the computation by using a register 915 as the recording medium.

Further, it is possible to implement the parts which are referred to as “—unit” in the explanation of each embodiment by firmware stored in the ROM 913. In another way, it is also possible to implement the embodiment using only software, only hardware, a combination of software and hardware, or a combination of software and hardware or firmware.

Further, programs for implementing the foregoing embodiments can be stored in a recording device using recording medium such as a magnetic disk drive 920, FD, an optical disk, CD, MD, DVD, etc.

According to the present invention, it is possible to provide a prefetch control circuit which is especially effective, for example, in a system that processes data which has low probability of re-referencing after being once referenced and which can be implemented by less hardware resource.

Having thus described several particular embodiments of the present invention, various alterations, modifications, and improvements will readily occur to those skilled in the art. Such alterations, modifications, and improvements are intended to be part of this disclosure, and are intended to be within the spirit and scope of the present invention. Accordingly, the foregoing description is by way of example only, and is not intended to be limiting. The present invention is limited only as defined in the following claims and the equivalents thereto.

What is claimed is:

1. A control circuit comprising:
a main memory for storing data;
a cache memory for reading and storing the data stored in the main memory by a unit of specific size as a cache line;
an operation processing unit for inputting the data stored in the cache memory and performing an operation process based on the data input;
a cache hit discriminating unit for discriminating a cache hit showing that target data which is used for the operation process performed by the operation processing unit is stored in the cache memory or a cache miss showing that the target data is not stored in the cache memory, and when the cache miss is discriminated, obtaining the target data from the main memory by the unit of specific size to store in the cache memory as a cache line;
a data discriminating unit, when the cache hit discriminating unit discriminates the cache hit, for discriminating the cache line including the target data is different from the cache line including data used for a previous operation process; and
a controlling unit for controlling caching operation, so that when the data discriminating unit discriminates the cache line including the target data is different from the cache line including the data used for the previous operation process, the data stored in the main memory is obtained by the unit of specific size, the data obtained by the unit of specific size is replaced with the cache line including the data used for the previous operation process, and the data obtained is stored in the cache memory as the cache line, and when the data discriminating unit discriminates the cache line including the target data is same as the cache line including the data used for the previous operation process, the cache line including the data used for the previous operation process is not replaced.

2. The control circuit of claim 1,
wherein the controlling unit, when the data stored in the main memory is replaced with the cache line including the data used for the previous operation process, obtains data stored in a subsequent area to data which corresponds to a cache line other than the cache line to be replaced, replaces the cache line with the data obtained to store in the cache memory.

3. The control circuit of claim 1, wherein
the cache memory reads a plurality pieces of the data stored in continuous areas in the main memory by the unit of specific size as the cache line and stores in continuous entries; and
the controlling unit, when the data discriminating unit discriminates that the cache line including the target data is different from the cache line including data used for the previous operation process, obtains a plural pieces of the data stored in the main memory by the unit of specific size, replaces cache lines from an entry of the cache line including the data used for the previous operation process to an entry which is one entry before the cache line including the target data with the plurality pieces of the data obtained by the unit of specific size to store in the cache memory.

4. The control circuit of claim 1, further comprising
a command suspending unit for analyzing data included in the cache line stored in the cache memory, and as a result of analyzing, when at least one of data showing a branch instruction and data showing an end command is discriminated, suspending the controlling unit from replacing the data stored in the main memory with the cache line stored in the cache memory to store in the cache memory.

5. The control circuit of claim 1, wherein
the operation processing unit includes:
a cache accessing unit for inputting data from the cache memory;
a decoding unit for decoding the data input by the cache accessing unit; and
an operating unit for performing an operation process based on the data decoded by the decoding unit,
wherein the cache accessing unit inputs data which is stored in the cache memory after the data that has been input, analyzes the data input, when the data analyzed shows a branch instruction, in parallel with the operation process by the operating unit, obtains data stored in a branched address shown by the data analyzed from the main memory to store in the cache memory.

6. A control circuit comprising:
a main memory for storing data;
a cache memory for reading and storing the data stored in the main memory by a unit of specific size as a cache line;
an operation processing unit for inputting the data stored in the cache memory and performing an operation process based on the data input;
a cache hit discriminating unit for discriminating a cache hit showing that target data which is used for the operation process performed by the operation processing unit is stored in the cache memory or a cache miss showing that the target data is not stored in the cache memory, and when the cache miss is discriminated, obtaining the target data from the main memory by the unit of specific size and storing in the cache memory as the cache line; and
a controlling unit for controlling a caching operation, so that when the data discriminating unit discriminates the cache miss, data stored in an area, which is subsequent to an area storing data corresponding to the data stored in the cache memory as the cache line stored by the cache hit discriminating unit, in the main memory is obtained by the unit of specific size, the data obtained by the unit of specific size is replaced with a cache line other than the cache line which has been stored by the cache hit discriminating unit to store in the cache memory as a cache line.

7. A control circuit comprising:
a main memory for storing data;
a cache memory for reading the data stored in the main memory by a unit of a specific size as a cache line, storing the cache line, and discriminating whether the cache line stored is valid or invalid;
an operation processing unit for inputting data of the cache line stored in the cache memory, and performing an operation process based on the data input;
a controlling unit for controlling a caching operation before the operation process performed by the operation processing unit, so that the data stored in the main memory is obtained by the unit of specific size, the data obtained by the unit of specific size is replaced with an invalid cache line to store in the cache memory as a cache line;
a standard value memory for storing at least one of a standard value of access frequency to the cache memory and a standard value of a number of valid cache lines stored in the cache memory;
a measuring unit for measuring at least one of access frequency to the cache memory and a number of valid cache lines stored in the cache memory; and
a measurement suspending unit, in at least one of cases when the access frequency to the cache memory measured by the measuring unit is equal to or less than the standard value of the access frequency stored in the standard value memory and when the number of valid cache lines measured by the measuring unit is equal to or greater than the standard value of the number of valid cache lines stored in the standard value memory, before the operation process, for suspending the controlling the caching operation from obtaining the data stored in the main memory by the unit of specific size, replacing the data obtained by the unit of specific size with the invalid cache line to store in the cache memory as a cache line.

8. A control circuit comprising:
a main memory for storing data;
a cache memory for reading and storing the data stored in the main memory;
a cache accessing unit for inputting the data from the cache memory;
a decoding unit for decoding the data input by the cache accessing unit; and
an operating unit for performing an operation process based on the data decoded by the decoding unit, wherein
the cache accessing unit, in parallel to the operation process by the operating unit, obtains from the main memory data stored in an address generated during the operation process performed by the operating unit to store in the cache memory.

9. A control method comprising:
storing data in a main memory;
reading and storing the data stored in the main memory by a unit of specific size as a cache line;
inputting the data stored in the cache memory and performing an operation process based on the data input;
discriminating a cache hit showing that target data which is used for the operation process is stored in the cache memory or a cache miss showing that the target data is not stored in the cache memory, when it is discriminated as the cache miss, obtaining the target data from the main memory by the unit of specific size to store in the cache memory as a cache line;
when the cache hit is discriminated, discriminating the cache line including the target data is different from the cache line including data used for a previous operation process; and
controlling a caching operation so that, when it is discriminated that the cache line including the target data is different from the cache line including the data used for the previous operation process, the data stored in the main memory is obtained by the unit of specific size, the data obtained by the unit of specific size is replaced with the cache line including the data used for the previous operation process to store in the cache memory as a cache line, and when it is discriminated that the cache line including the target data is same as the cache line including the data used for the previous operation process, the cache line including the data used for the previous operation process is not replaced.

10. A control method comprising:
storing data in a main memory;
reading and storing the data stored in the main memory by a unit of specific size as a cache line;
inputting the data stored in the cache memory and performing an operation process based on the data input;
discriminating a cache hit showing that target data which is used for the operation process is stored in the cache memory or a cache miss showing that the target data is not stored in the cache memory, and when it is discriminated as the cache miss, obtaining the target data from the main memory by the unit of specific size to store in the cache memory as a cache line; and
when the cache miss is discriminated, obtaining data stored in an area, which is subsequent to an area storing data corresponding to the data stored in the cache memory as the cache line, in the main memory by the unit of specific size, and replacing the data obtained by the unit of specific size with a cache line other than the cache line which has been stored in the cache memory to store in the cache memory as a cache line.

11. A control method comprising:
storing data in a main memory;
reading the data stored in the main memory by a unit of a specific size as a cache line, storing the data as the cache line in a cache memory, and managing whether the cache line stored is valid or invalid;
inputting data of the cache line stored in the cache memory, and performing an operation process based on the data input;
controlling a caching operation before the operation processing, so that the data stored in the main memory is obtained by the unit of specific size, the data obtained by the unit of specific size is replaced with an invalid cache line to store in the cache memory as a cache line;
storing in a standard value memory at least one of a standard value of access frequency to the cache memory and a standard value of a number of valid cache lines stored in the cache memory;
measuring at least one of access frequency to the cache memory and a number of valid cache lines stored in the cache memory; and
in at least one of cases when the access frequency to the cache memory measured is equal to or less than the standard value of the access frequency stored in the standard value memory and when the number of valid cache lines measured is equal to or greater than the standard value of the number of valid cache lines stored in the standard value memory, before the operation process, suspending the controlling the caching operation from obtaining the data stored in the main memory by the unit of specific size, replacing the data obtained by the unit of specific size with the invalid cache line to store in the cache memory as a cache line.

12. A control method comprising:
storing data in a main memory;
reading the data stored in the main memory and storing in a cache memory;
inputting the data from the cache memory;
decoding the data input; and
performing an operation process based on the data decoded,
when the data is input from the cache memory, in parallel with the operation process, obtaining data in an area shown by an address generated during the operation process to store in the cache memory.
